(19) United States
(12) Patent Application Publication
(10) Pub. No.: US 2013/0141840 A1
(43) Pub. Date: Jun. 6, 2013

(54) ON-BOARD POWER SUPPLY

(71) Applicant: FastCAP Systems Corporation, Boston, MA (US)

(72) Inventors: John J. Cooley, Boston, MA (US); Ricardo Signorelli, Cambridge, MA (US); Morris Green, Brighton, MA (US); Nicolo M. Brambilla, Brookline, MA (US)

(73) Assignee: FastCAP SYSTEMS Corporation, Boston, MA (US)

(21) Appl. No.: 13/706,055

(22) Filed: Dec. 5, 2012

Related U.S. Application Data
(60) Provisional application No. 61/566,914, filed on Dec. 5, 2011.

(51) Int. Cl. H01G 9/035; H01G 9/00

(52) U.S. Cl. CPC H01G 9/035; H01G 9/0029; H01G 13/00
USPC 361/503; 29/25.03

(57) ABSTRACT

A power supply for a device disposed on a substrate is provided. An electrolytic double layer capacitor disposed in a circuit to provide power to circuit components is described. Aspects of fabrication are provided.

### RELATED APPLICATIONS

This patent application is filed under 35 U.S.C. §111(a), and claims priority under 35 U.S.C. §119(e) to U.S. Patent Application No. 61/566,914, filed Dec. 5, 2011, the entire disclosure of which is incorporated by reference herein in its entirety.

### BACKGROUND

1. Technical Field

The present invention relates to a power storage disposed on a substrate, and in particular, to providing a capacitor that includes carbon containing electrodes.

2. Description of the Related Art

Many circuit components consume substantial power. Some of these devices require bursts of high-power. Given the ever shrinking size of electronics, delivery of power to these components can be a challenge.

Thus, what are needed are methods and apparatus for providing high power on a circuit board or wafer. Preferably, the methods and apparatus are simple to provide and thus offer reduced cost of manufacture.

### SUMMARY

In certain embodiments, an electrolytic double layer capacitor is disposed in a circuit to provide power to circuit components. Aspects of fabrication are provided.

In one aspect, a power supply for a device disposed on a substrate is provided. The power supply comprises, in certain embodiments, an energy storage device electrically coupled to a conductor, the storage device surrounded by an electrolyte that is substantially hermetically sealed from a surrounding environment.

In another aspect, a method for providing a power supply is described. The method comprises, in certain embodiments, disposing an energy storage device onto a conductor within a substrate; disposing a housing over the energy storage device; filling the housing with an electrolyte; and hermetically sealing the housing from an external environment.

### BRIEF DESCRIPTION OF DRAWINGS

The foregoing and other features and advantages of the invention are apparent from the following detailed description taken in conjunction with the accompanying drawings in which:

FIG. 1 is a side cutaway view of a power supply disposed on a wafer;

FIG. 2 is a side cutaway view of another embodiment of the power supply disposed on a wafer;

FIG. 3 is a block diagram depicting a current collector of the power supply and a supply of carbon nanotubes for transfer thereon;

FIG. 4 is a block diagram depicting loading of the carbon nanotubes onto the current collector;

FIG. 5 is a block diagram depicting aspects of the energy storage device shown in FIG. 1; and

FIGS. 6A, 6B, and 6C, collectively referred to herein as FIG. 6, depict aspects of additional embodiments of the power supply.

### DETAILED DESCRIPTION

Disclosed are methods and apparatus for providing a power supply (e.g., a capacitor such as an ultracapacitor) on a circuit board or wafer. As an overview, the power supply includes embodiments of an electrolytic double layer capacitor (EDLC). At least some components for the EDLC are fabricated into a host wafer or a host circuit board. The power supply is available to meet immediate and local power demand from other components on the host.

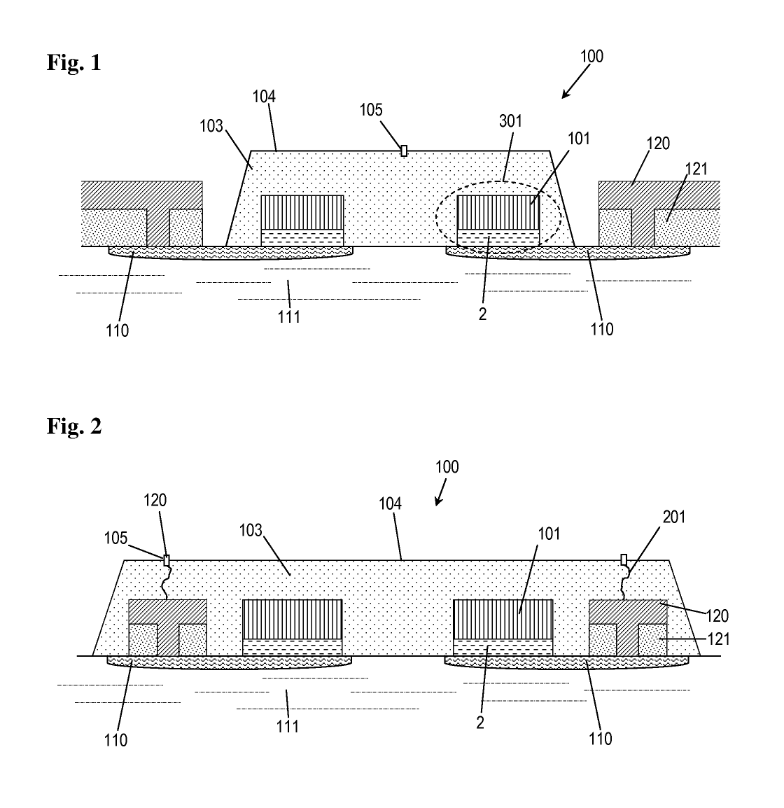

Referring now to FIG. 1, there is shown an exemplary embodiment of a power supply 100. Power supply 100 can be, for example, a capacitor such as an ultracapacitor. The power supply 100 is disposed on a substrate. The substrate can be, for example, a wafer, such as silicon wafer 111 illustrated in FIG. 1. In other embodiments, the substrate can be a circuit board. In FIG. 1, wafer 111 comprises p-doped silicon. Fabricated into the wafer 111 are two wells 110. The wells 110 can include, for example, n++ doped silicon. Disposed on each of the wells 110 is energy storage device 301 (which can also be referred to as an energy storage, and which will be discussed in greater detail herein). Generally, the energy storage device 301 may include a current collector 2 in electrical contact with a respective well 110, and is also host to a carbon layer 101. In some embodiments, the carbon layer 101 includes carbon nanotubes. Also included on the wafer 111, in electrical contact with each well 110, is at least one terminal 120.

The power supply 100 includes a supply of electrolyte 103. The electrolyte 103 may assume a variety of physical forms, and may include a variety of compositions. In short, the electrolyte includes material to provide for the flow of ions within the power supply 100. The actual material selected and used for the electrolyte may be determined according to the standards of a designer, manufacturer, user or the like. Exemplary cations for the electrolyte 103 include imidazolium, pyrazinium, piperidinium, pyridinium, pyrimidinium, and pyrrolidinium. Generally, these cations may be selected as exhibiting high thermal stability, a low glass transition temperature (Tg), as well as high conductivity and exhibited good electrochemical performance over a wide range of temperatures.

Exemplary anions for the electrolyte 103 may include tetracyanoborate (TCB) and bis(trifluoromethylsulfonyl)amide (NTF2). Generally, these anions may be selected for exhibiting hydrophobic properties, as well as high fluidicity (low viscosity).

Generally, the power supply 100 is encased in a housing 104. The housing 104 may include a fill port for filling the housing with electrolyte 103. Generally, each penetration into the housing 104, such as the fill port, is sealed with a hermetic seal 105. In certain embodiments, the hermetic seal has a leak rate of helium gas of no greater than about 5.0×10⁻⁶ standard cubic centimeters per second (and may exhibit a leak rate of helium gas of no greater than about 5.0×10⁻¹⁰ standard cubic centimeters per second) when a pressure gradient of 1 atm is applied across the seal. One of ordinary skill in the art would understand that the standard volume (e.g., in standard cubic centimeters) of a gas is determined when the gas is at atmospheric temperature (about 25° C.) and pressure (1 atm). Leak detection may be accomplished, for example, by use of a tracer gas, such as helium. Using a tracer gas such as helium for leak testing is advantageous as it is a dry, fast, accurate and non-destructive method. In one example of this technique, which is generally known to those of ordinary skill in the art for determining the presence of a hermetic seal, the power supply is placed into an environment of helium. The power supply is subjected to pressurized helium, for example, at a gauge pressure of about 1 atm (i.e., about 1 atm higher than atmospheric pressure). The power supply is then placed into a vacuum chamber that is connected to a detector capable of monitoring helium presence (such as an atomic absorption unit), and a vacuum is established such that a pressure gradient of 1 atm is present across the seal (e.g., by establishing a vacuum of about 1×10⁻² Torr outside the power supply). With knowledge of pressurization time, pressure, and internal volume, the leak rate of the power supply may be determined. A hermetic seal may be provided by covering the fill port with a cap and then bonding the cap to the housing, for instance, by laser welding. By providing the hermetic seal 105, the power supply 100 is assured efficient operation with limited interference from impurities, such as halides and moisture. The housing 104 may be disposed on the wafer 111 through a variety of techniques as are known in the art. In certain embodiments, the housing is bonded to the substrate. For example, the housing 104 may be placed and welded or soldered onto the wafer 111. In some embodiments, the housing may be annealed or thermally bonded to the substrate.

Each terminal 120 may include an insulative layer 121, such as one fabricated from silicon dioxie (SiO₂). The terminal 120 provides for electrical access, through the well 110, to energy stored in the energy storage device 301. The terminal 120 may be a part of another component, such as a transistor (FET, MOSFET, and the like), or other such device. Generally, electrical access to the power supply 100 is realized through the terminal 120. Each terminal 120 may service charging and discharging of the power supply 100. In some embodiments, charging and discharging of the power supply 100 is accomplished through separate terminals 120. In some of these embodiments, a plurality of wells 110 may also be included.

The current collector 2 may be fabricated onto the wafer 111 through various techniques. For example, conventional lithography may be used. The current collector 2 may be sputtered onto the wafer 111, or otherwise applied after fabrication of components on the wafer 111. Likewise, the wells 110 may be fabricated with traditional or conventional techniques for fabrication of the wafer 111.

Further aspects of the power supply 100 are now presented.

In some embodiments, the doped silicon well 110 and flat substrate area for attaching the housing 104 may be made by growing thermal oxide and patterning around the n++ regions; implanting donor material (e.g. ion beam deposition of phosphorous or arsenic followed by annealing (in exposed Si squares)); re-patterning the oxide after donor implementation to allow for a flat exposed substrate circumference around the site of active layers for seating the housing 104, for instance by re-etching the SiO₂ in a fluorine plasma.

If the surface is made rough by several deposition and masking steps, for instance those that may be required to implement the surrounding integrated circuitry, a reflow process may be used to re-planarize the surface. Specifically, the exposed substrate (wafer 111) upon which the housing 104 will sit may be deposited with an insulator film formed of, for example, silicon dioxide (SiO₂) along with at least one of phosphorous and boron additives for softening. The system may then be heated to about 900 degrees Celsius to planarize the insulator film. The added insulator layer may also be useful in preventing interaction between the electrolyte 103 or the housing (if a conducting housing 104 is used) or with the silicon substrate and the surrounding circuitry.

Aspects of an exemplary overall process for fabrication include first processing the silicon wafer 111 to include the integrated circuitry as well as the all of the components needed for the power supply 100 except the carbon layer 101, growth substrates, electrolyte 103, the housing 104 and associated wirebonds. The wafer 111 is then masked to expose only the regions where the carbon layers 101 will reside. Deposition of a growth layer can then be performed on the unmasked portion. Growth layers are generally material layers that promote the formation of energy storage media such as, for example, carbon materials (e.g., carbon nanotubes, carbon fibers, activated carbon, rayon, graphene, aerogel, and carbon cloth). In certain embodiments, the growth layer comprises a catalyst, such as a metal catalyst, which can be used to catalytically form carbon materials. For example, the growth layer can, in certain embodiments, include at least aluminum and/or iron catalyst particles. An adhesion layer of titanium (or other suitable material) may be deposited first to improve coupling between the growth layer and the silicon. An energy storage medium can then be deposited on the growth layer. Energy storage media include materials capable of storing an electrical charge within the energy storage device. The energy storage medium can comprise, for example, a carbon-based material, such as the carbon-based materials used in the carbon layer described elsewhere herein. The carbon layer 101 may then be grown on the growth layer using a chemical vapor deposition (CVD) process. In this case, the growth layer may take the place of the current collector 2.

Another example of the power supply 100 is provided in FIG. 2. In this example, a lead 201 provides electrical access to respective components, and is coupled to a respective terminal 202 (such as one integrated into the housing 104). In this example, the terminal 202 may also provide for the hermetic seal 104.

In this embodiment, the metal contacts are disposed within the housing 104. Each of the hermetic seals 104 includes an electrical feed-through to which wires are wire-bonded. The wires are also wire-bonded to the metal contacts. This embodiment may be useful when it is important to limit the length of current path that flows through the heavily n-doped silicon. This may be significant because physical properties of the silicon limit the doping level such that the resulting conductivity of the doped silicon can be no more than approximately 1/3,000th that of copper. Thus a minimal length of doped silicon should be used when series resistance is to be kept low. A maximum doping level is approximately 10¹⁹ dopants/cm³, yielding a typical doped silicon resistivity of about 5 mOhms-cm.

In exemplary fabrication of this embodiment, wire-bonding of z-folded leads 201 to the internal portion of the electrical feedthroughs may be used, leaving an excess length of wire. The opposite ends of the leads 201 are then also wire-bonded to respective wire bond pads for the capacitor electrodes.

In various embodiments, the housing 104 may be bonded to the substrate by annealing or thermal bonding. The housing 104 may be insulating or conducting. Insulating materials are generally those which do not readily conduct electricity. Electrically insulating materials can have, in some embodiments, an electrical resistivity of greater than about 1×10¹, greater than about 1×10⁴ ohm-m, greater than about 1×10⁸ ohm-m, greater than about 1×10¹² ohm-m, greater than about 10¹⁶ ohm-m, or greater than about 10²⁰ ohm-m at 20° C. Conductors are materials generally capable of readily conducting electricity. In certain embodiments, the conductor can have an electrical resistivity of less than about 1×10⁰ ohm-m, less than about 1×10⁻² ohm-m, less than about 1×10⁻⁴ ohm-m, or less than about 1×10⁻⁶ ohm-m at 20° C.

If the housing 104 is conducting, then the housing 104 may be used as an external connection to one of the electrodes (in this second embodiment involving internal contacts). At least one insulator to metal seal is used to form the external connection to the other electrode. Advantageously, the insulator to metal seal may make use of existing technology such as available electrode inserts that include glass-to-metal seals (and may include those fabricated from stainless steel, tantalum or other advantageous materials and components). In the case that an insert is used to provide for an insulator to metal seal, the insert may be bonded to the housing by way of various welding techniques, for instance, laser welding or resistance welding. The insert may be bonded to the housing prior to disposing the housing on the substrate to ease fabrication. Material for constructing the insulator may include, without limitation, various types of glass, including high temperature glass, ceramic glass or ceramic materials. Generally, materials for the insulator are selected according to, for example, structural integrity and electrical resistance (i.e., electrical insulation properties).

Generally, the power supply 100 stores charge in the carbon layer 101. The carbon layer 101 may include any one or more of a variety of forms of carbon. Examples include activated carbon, carbon fibers, rayon, graphene, aerogel, carbon cloth, and carbon nanotubes and the like. It should be understood that, in certain embodiments, the carbon layer is not purely carbon, but rather, may include materials other than carbon such as, for example, impurities, binders, fillers, or other non-carbon materials. In certain embodiments, the carbon layer comprises at least one of activated carbon, carbon fibers, rayon, graphene, aerogel, carbon cloth and carbon nanotubes. In certain embodiments, at least about 50 weight % (i.e., wt %), at least about 75 wt %, at least about 90 wt %, or at least about 99 wt % of the mass of the carbon layer is made up of carbon, including carbon in any of the forms mentioned in this paragraph or elsewhere herein. In certain embodiments, at least about 50 wt %, at least about 75 wt %, at least about 90 wt %, or at least about 99 wt % of the mass of the carbon layer is made up of carbon nanotubes.

In some embodiments, such as where carbon nanotubes are used, the carbon layer 101 may be disposed on the current collector 2 using techniques disclosed further herein.

In order to provide some context for the teachings herein, reference is first made to U.S. Pat. No. 7,897,209, entitled “Apparatus and Method for Producing Aligned Carbon Nanotube Aggregate.” This patent is incorporated herein by reference, in its entirety.

The foregoing patent (the “'209 patent”) teaches a process for producing aligned carbon nanotube aggregate. Accordingly, the teachings of the '209 patent, which are but one example of techniques for producing aligned carbon nanotube aggregate, may be used to produce carbon nanotube aggregate (CNT) referred to herein.

In order to provide more detail on the power supply, some context is provided. That is, one example of a power supply 100 as provided herein is provided in U.S. Patent Application Publication No. 2007-0258192, entitled “Engineered Structure for Charge Storage and Method of Making,” also incorporated herein by reference, in its entirety.

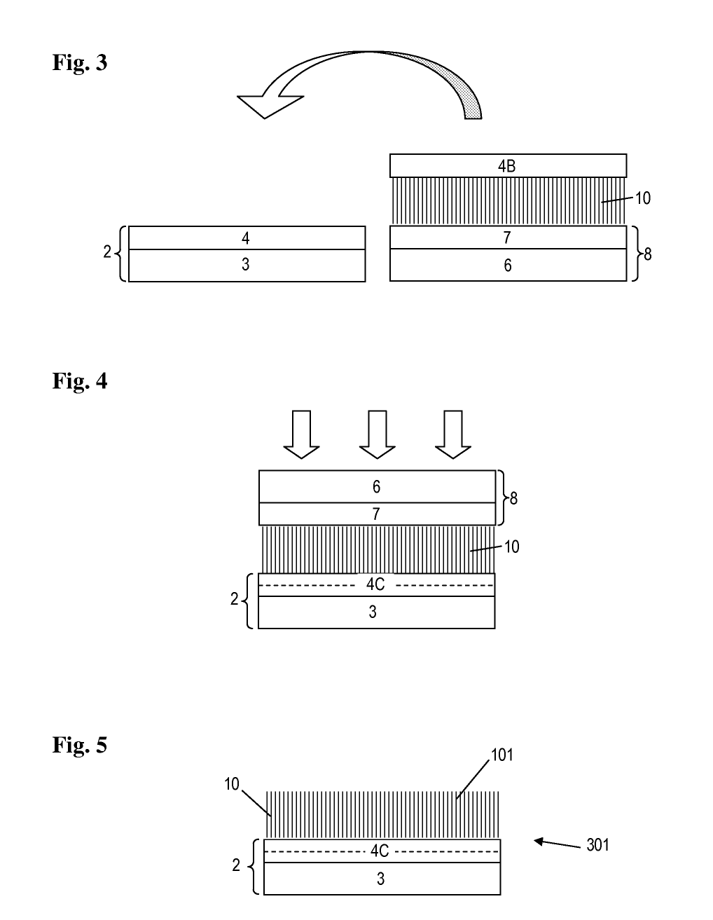

Referring now to FIG. 3, there is a shown a first component, a current collector 2. Generally, the current collector 2 includes a conductor layer 3, and may include a bonding layer 4. The conductor layer 3 may be fabricated from any material suited for conducting charge in the intended application. Exemplary materials include elemental metals such as aluminum. In certain embodiments, the conductor layer comprises doped silicon. The conductor layer 3 may be presented as a foil, a mesh, a plurality of wires or in other forms. Generally, the conductor layer 3 is selected for properties such as conductivity and being electrochemically inert.

In some embodiments, the conductor layer 3 is prepared by removing an oxide layer thereon. The oxide may be removed by, for example, etching the conductor layer 3 with KOH.

In some embodiments, a bonding layer 4 is disposed on the conducting layer 3. The bonding layer 4 may appear as a thin layer, such as layer that is applied by sputtering, e-beam or through another suitable technique. In various embodiments, the bonding layer 4 is between about 10 nm to about 20 nm. Generally, the bonding layer 4 is selected for its properties such as conductivity, being electrochemically inert and compatibility with the material of the conductor layer 3. Some exemplary materials include aluminum, gold, silver, palladium, tin and platinum as well as alloys or in combinations of materials, such as Fe—Cr—Ni.

A second component includes a substrate 8 that is host to the carbon nanotube aggregate (CNT) 10. Some exemplary techniques for providing the CNT 10 are provided in the '209 patent. In the embodiment shown in FIG. 3, the substrate 8 includes a base material 6 with a thin layer of a catalyst 7 disposed thereon.

In general, the substrate 8 is at least somewhat flexible (i.e., the substrate 8 is not brittle), and is fabricated from components that can withstand environments for deposition of the CNT 10 (e.g., a high-temperature environment of between about 400 degrees Celsius to about 1,100 degrees Celsius).

Once the CNT 10 have been fabricated, an additional bonding layer 4B is disposed thereon. In some embodiments, the additional bonding layer 4B is between about 50 nm to 100 nm thick. Subsequently, the bonding layer 4 of the current collector 2 is mated with the additional bonding layer 4B disposed over the CNT 10, as shown in FIG. 4, in which bonding layer 4 and optional additional bonding layer 4B have been combined to form composite bonding layer 4C.

FIG. 4 illustrates aspects of mating the CNT 10 with the current collector 2. As implied by the downward arrows, pressure is applied onto the base material 6. The application of the CNT 10 may be accompanied by heating of the components. As an example, when platinum is used in the bonding layers 4, heating to between about 200 degrees Celsius to about 250 degrees Celsius is generally adequate. Subsequently, the CNT 10 and the catalyst 7 are separated, with a resulting layer of CNT 10 disposed onto the current collector 2.

Various post-manufacture processes may be completed to encourage separation of the CNT 10 from the catalyst 7. For example, following completion of deposition, the substrate 8 including the CNT 10 thereon may be exposed to (e.g., heated in) an environment of room air, carbon dioxide or another appropriate environment. Generally, the post-manufacture treatment of the CNT 10 includes slowly ramping the CNT 10 to an elevated temperature, and then maintaining the CNT 10 at temperature for a few hours at a reduced pressure (i.e., below 1 atmosphere).

As shown in FIG. 5, the energy storage device 301 results from the process of transferring the CNT 10 onto the current collector 2.

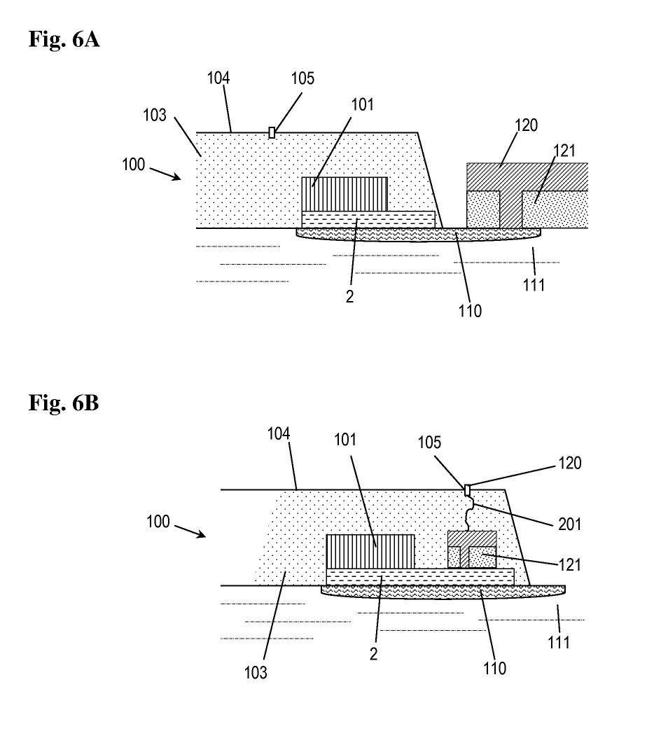

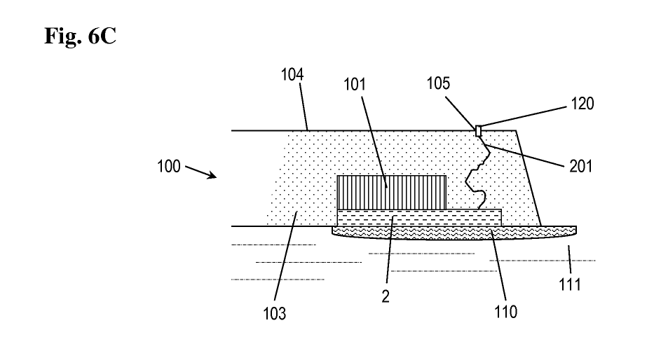

In FIG. 6, aspects of additional embodiments are shown. In FIG. 6A, the carbon layer 101 does not cover the entire current collector 2. Accordingly, additional components may be coupled with the current collector 2. Examples making use of exposed current collector 2 are depicted in FIG. 6B, where a component (e.g., an electrical lead) is coupled with the current collector 2. In FIG. 6C, lead 201 is coupled with the current collector 2.

Having thus disclosed aspects of the power supply 100, it should be realized that use of the power supply provides a great deal of flexibility. For example, a substantial amount of energy may be stored in or on an integrated circuit housing when compared with other technologies. This may be used to provide for power buffering, local back-up and the like. Advantageously, the form factor provides for relatively simple incorporation of the power supply into existing forms of micro-electronics.

Having disclosed aspects of embodiments of the production apparatus and techniques for fabricating aggregates of carbon nanotubes and a power supply making use of carbon nanotubes (and/or other forms of carbon), it should be recognized that a variety of embodiments of apparatus and methods may be realized. Accordingly, while the invention has been described with reference to exemplary embodiments, it will be understood by those skilled in the art that various changes may be made and equivalents may be substituted for elements thereof without departing from the scope of the invention. For example, steps of fabrication may be adjusted, as well as techniques for layering, materials used and the like. Many modifications will be appreciated by those skilled in the art to adapt a particular arrangement or material to the teachings of the invention without departing from the essential scope thereof. Therefore, it is intended that the invention not be limited to the particular embodiment disclosed as the best mode contemplated for carrying out this invention but as described by the appended claims.

1. A power supply for a device disposed on a substrate, the power supply comprising:
an energy storage device electrically coupled to a conductor, the storage device surrounded by an electrolyte that is substantially hermetically sealed from a surrounding environment.

2. The power supply of claim 1, wherein the storage device comprises at least one carbon layer for storing the energy, the layer comprising at least one of activated carbon, carbon fibers, rayon, graphene, aerogel, carbon cloth and carbon nanotubes.

3. The power supply of claim 2, wherein the energy storage device comprises at least one of a current collector and a growth layer as a host to the carbon layer.

4. The power supply of claim 1, wherein the electrolyte is contained within a housing.

5. The power supply of claim 4, wherein the housing is one of insulating and conducting.

6. The power supply of claim 4, wherein the housing comprises a fill-port for filling the power supply with the electrolyte.

7. The power supply of claim 1, further comprising at least one terminal adapted to provide electrical access to the energy storage device.

8. The power supply of claim 7, wherein the terminal is provided within a housing that contains the electrolyte or external to a housing that contains the electrolyte.

9. The power supply of claim 8, wherein the terminal is disposed within the housing, and the terminal further comprises a lead to provide an electrical contact on the housing.

10. The power supply of claim 1, wherein the conductor comprises doped silicon.

11. The power supply of claim 1, wherein the substrate comprises one of a silicon wafer and a circuit board.

12. A method for providing a power supply, the method comprising:
disposing an energy storage device onto a conductor within a substrate;
disposing a housing over the energy storage device;
filling the housing with an electrolyte; and
hermetically sealing the housing from an external environment.

13. The method of claim 12, wherein disposing the energy storage device comprises transferring a current collector onto the conductor.

14. The method of claim 13, wherein disposing the energy storage device further comprises transferring energy storage media onto the current collector.

15. The method of claim 12, wherein disposing the energy storage device comprises disposing a growth layer onto the substrate.

16. The method of claim 15, wherein disposing the energy storage device further comprises depositing energy storage media onto the growth layer.

17. The method of claim 16, wherein depositing the energy storage media comprises performing chemical vapor deposition of the energy storage media on the growth layer.

18. The method of claim 12, wherein the energy storage device comprises at least one carbon layer that comprises at least one of activated carbon, carbon fibers, rayon, graphene, aerogel, carbon cloth and carbon nanotubes.

19. The method of claim 12, wherein disposing the housing comprises bonding the housing to the substrate.

20. The method of claim 12, wherein filling comprises filling the housing with at least one of imidazolium, pyrazinium, piperidinium, pyridinium, pyrimidinium, pyrrolidinium, tetracyanoborate (TCB) and bis(trifluoromethylsulfonyl)amide (NTF2).
